(19) United States
(12) Patent Application Publication
(10) Pub. No.: US 2024/0246035 A1
(43) Pub. Date: Jul. 25, 2024

(54) A FILTRATION SYSTEM WITH A LIFTING ARRANGEMENT FOR MEMBRANES

(71) Applicant: Tetra Laval Holdings & Finance S.A., Pully (CH)

(72) Inventor: Magnus ANDERSSON, Viby J (DK)

(73) Assignee: Tetra Laval Holdings & Finance S.A., Pully (CH)

(21) Appl. No.: 18/560,473

(22) PCT Filed: Jun. 2, 2022
(86) PCT No.: PCT/EP2022/065002

§ 371 Date: Nov. 13, 2023

(30) Foreign Application Priority Data
Jun. 3, 2021 (EP) 21177532.5

(51) Int. Cl. B01D 65/00

(52) U.S. Cl. CPC B01D 65/00; B01D 2313/56; B01D 2313/57

(57) ABSTRACT

A filtration system comprising a membrane arrangement comprising membrane housings extending in a first direction and having openings that are located in a common plane and face a common area, and membranes arranged inside the membrane housings and configured to be replaced via the openings, and a lifting arrangement comprising a support frame having a beam that extends along the common plane and is provided vertically above the common area, and a gripper unit slidably attached to the beam and arranged to grip the membranes and transport the membranes in a direction along the common plane.

### TECHNICAL FIELD

The invention relates to filtration systems for food processing lines. More specifically, it is related to a filtration system comprising a membrane arrangement and to equipment and methods for replacing membranes in the membrane arrangement.

### BACKGROUND ART

Today, membrane filtration is commonly used for processing and separating components in milk and other liquid food products. To assure that different components of e.g. milk are separated adequately, membranes need to be replaced at frequent intervals. How often depends on a number of factors, such as properties of the food product and quality of the membranes. A factor sometimes overlooked is that the membranes sometimes need to be replaced too soon due to damages caused during handling of the membranes.

To facilitate the handling of the membranes for the operator and thereby reducing the risk of damages, which can reduce the operational lifetime of the membrane, the membranes are often produced in lengths such that these can be handled by an operator. As an effect of this, it is common that membrane housings are made to contain several membranes placed after one another. In this way, when the membranes are to be replaced these are pulled out of the membrane housing one by one, and thereafter new membranes are pushed one by one into the membrane housing.

Even though the membranes are produced in lengths such that these can be efficiently and safely handled by operators, there is still a risk of damaging the membranes when pushing these into the membrane housings.

### SUMMARY

It is an object of the invention to at least partly overcome one or more of the above-identified limitations of the prior art. In particular, it is an object to provide a filtration system where the risk of damaging the membranes when pushing these into the membranes housings is mitigated.

According to a first aspect a filtration system is provided, said filtration system comprising a membrane arrangement comprising membrane housings extending in a first direction and having openings that are located in a common plane and face a common area, and membranes arranged inside the membrane housings and configured to be replaced via the openings. The filtration system also comprises a lifting arrangement comprising a support frame having a beam that extends along the common plane and is provided vertically above the common area, and a gripper unit slidably attached to the beam and arranged to grip the membranes and transport the membranes in a direction along the common plane.

An advantage with having the filtration system provided with the lifting arrangement is that membranes may be handled and inserted securely into the membrane housings, thereby reducing the risk of damaging the membranes.

The membrane housings may be arranged in horizontal rows and vertical columns. This configuration provides for convenient and efficient operation of the lifting arrangement.

The membranes may be spiral wound membranes that are arranged in groups in the membrane housings, where the membranes in each group are positioned after one another in the first direction. An advantage of having several membranes in each membrane housing is that the membranes may be produced at a length easy to handle for the operator when using the lifting arrangement. This provides for that the risk of damaging the membranes can be further reduced.

The beam may be provided with a groove to which the gripper unit is connected, for allowing the gripper unit to slide along the beam in the direction along the common plane. Having the beam provided with the groove provides for that the membrane can be reliably handled and moved in said direction.

The gripper unit may be attached to the beam via a hoist unit, the hoist unit may comprise a motor arranged to vertically move the gripper unit together with a membrane held by the gripper unit.

The gripper unit may comprise a pipe tong for gripping a membrane. Having the gripper unit embodied as a pipe tong provides for a reliable gripping mechanism that can easily be controlled for safe handling of the membranes.

The gripper unit may comprise a first arm, a second arm, a third arm and a fourth arm, wherein the first arm may be connected to the second arm via a first rotational point, the third arm may be connected to the first arm via a second rotational point, the fourth arm may be connected to the second arm via a third rotational point, the third arm may be connected to the fourth arm via the fourth rotational point. A first membrane holder is attached to the fourth arm, and a second membrane holder is attached to the third arm, for allowing the first and second membrane holder to clamp the membrane when the second arm is pulled upwards.

The gripper unit may comprise a locking device and a locking element, wherein the locking element may be rotationally connected to the second arm via a fifth rotational point, said locking device may further comprise a guiding element, fixedly attached and provided with a slanted top surface and a bottom surface recess, and a tilt element, rotationally attached via a tilt rotational point and provided with a slanted top surface and a bottom surface. The locking element further comprises a locking pin provided in a peripheral end of the locking element, such that: when the second arm is lowered the locking pin is introduced into the locking device and guided downwards via the slanted top surface of the tilt element and the slanted top surface of the guiding element; thereafter, when the second arm is lifted, the locking pin is caught in the bottom surface recess of the guiding element, thereby providing for that the first and second membrane holder are held apart; and thereafter, when the second arm is lowered and lifted, the locking pin is released from the bottom surface recess and pushed through between the guiding element and the tilt element by pushing the tilt element from a closed position to an open position via the bottom surface of the tilt element and out from the locking device.

An advantage with having the locking device is that the gripper unit may be lowered down onto the membrane, and once being in contact with the membrane the locking pin can be released from the bottom surface recess such that the membrane is gripped, or clamped, between the first and second membrane holders. Put differently, the membrane may be gripped without any specific locking action being required by the operator.

The support frame may be fixedly attached relative to the membrane arrangement. The support frame may be fixedly attached to the membrane housings. The support frame may be attached to the membrane housings via a first and a second pipe clamp. An advantage with having the support frame attached in this way is that the lifting arrangement can easily be mounted to an existing filtration system without introducing any new parts being in contact with the food product.

The filtration system may further comprise a support device arranged to be connected to one of the membrane housings at the opening of the membrane housing, and configured to support membranes that are pushed into or pulled out from the membrane housing. An advantage with having the support device is that the membrane may pulled out from the membrane housing into the support device and thereafter, while being held in the support device, the membrane may be gripped by the gripper unit. Conversely, when inserting a new membrane, the membrane may be placed into the support device by the gripper unit, and after being released by the gripper unit, be pushed into the membrane housing. Thus, the combination of the lifting arrangement and the support device provides for that the membranes can be handled even more securely such that the risk of damaging these can be reduced.

According to a second aspect it is provided a lifting arrangement arranged to be fixedly attached relative to a membrane arrangement such that a filtration system according to the first aspect is formed, said lifting arrangement comprising a support frame having a beam that extends along the common plane and is provided vertically above the common area, and a gripper unit slidably attached to the beam and arranged to grip the membranes and to transport the membranes in a direction B along the common plane.

An advantage with this second aspect is, in line with the first aspect, that the risk of damaging the membranes can be reduced, for example when retrofitting existing membrane arrangements with the lifting arrangement.

According to a third aspect it is provided a method for replacing membranes in a filtration system according to the first aspect, said method comprising
a) attaching the support device to an opening of one of the membrane housings of the filtration system,
b) pulling a membrane out from the membrane housing and into the support device,
c) gripping and lifting the membrane with the gripper unit,
d) moving the gripper unit with the membrane in the direction B along the common plane,
e) lowering and releasing the membrane in a drop off area,
f) repeating steps b) to e) until the membrane housing is empty,
g) gripping and lifting, from a pick-up area, a new membrane with the gripper unit,
h) sliding the gripping unit with the new membrane in the direction B along the common plane,
i) lowering and releasing the new membrane in the support device,
j) pushing the new membrane into the membrane housing,
k) repeating steps g) to k) until the membrane housing is full with new membranes,
l) removing the support device from the opening of the membrane housing, and
m) repeating steps a) to l) for a number of membrane housings of the filtration system.

Also for this third aspect, the advantage is that the risk of damaging the membranes can be reduced.

The features and advantages discussed in relation to the first aspect also apply to the second and third aspects even though not explicitly mentioned in relation to these aspects.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is a perspective view of a filtration system.

FIG. 2 is a detailed perspective of a lifting arrangement of the filtration system.

FIG. 3A generally illustrates the filtration system from above when a membrane is pulled out from a membrane housing.

FIG. 3B generally illustrates the filtration system from above when the membrane is moved, by using a carrier unit, from a membrane housing towards a drop off area.

FIG. 4A illustrates the carrier unit in further detail.

FIG. 4B illustrates a locking device of the carrier unit.

FIG. 5 is a flow chart illustrating a method for replacing a membrane.

### DETAILED DESCRIPTION

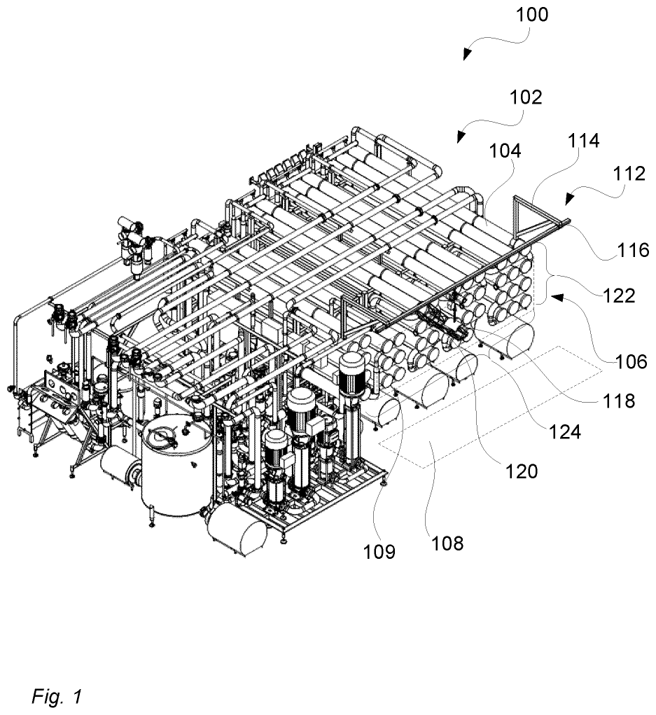

With reference to FIG. 1, a filtration system 100 is illustrated by way of example. The filtration system 100 can form part of a food processing line for milk or other liquid food products. The filtration system 100 may, for example, be used for separating different components of milk such that lactose free milk can be produced, but also for removing bacteria and spores without the need to heat treat the food products. To achieve this, different membranes may be used, e.g. spiral wound membranes.

The filtration system 100 can comprise a membrane arrangement 102 in turn comprising a number of membrane housings 104. As illustrated, to reduce footprint of the filtration system 100, the membrane housings 104 may be provided in horizontal layers placed on top of each other. The membrane housings 104 can be provided with openings 106 in one end to provide for that membranes inside the housing 104 can be replaced. The openings 106 may all face a common area 108 as illustrated such that an operator can replace membranes from one and the same side. Even though not illustrated, it is also an option to have some openings facing in an opposite direction such that there are two common areas in which the operator can replace the membranes. Further, it is also possible two have openings in both ends of the membrane housings 104.

Some or even all of the openings 106 may be arranged in a common plane 109. Since the membrane housings 104 in the illustrated example are provided in a number of horizontal layers arranged on top of each other, the openings 106 are arranged in this common plane 109 in rows 124 and columns 122.

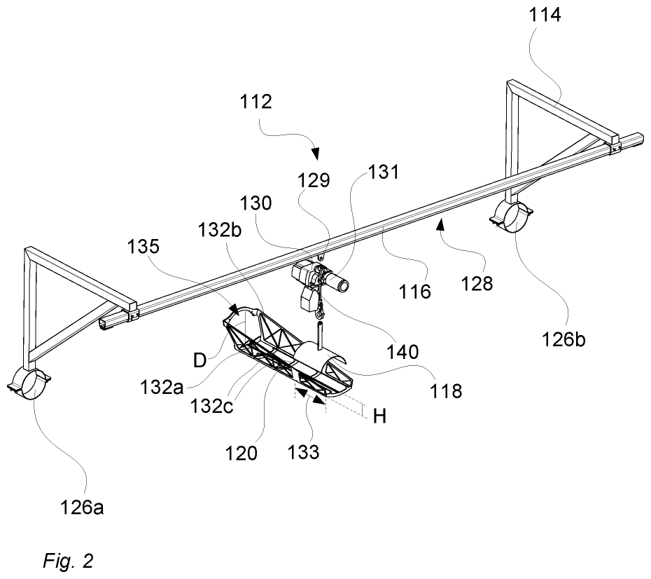

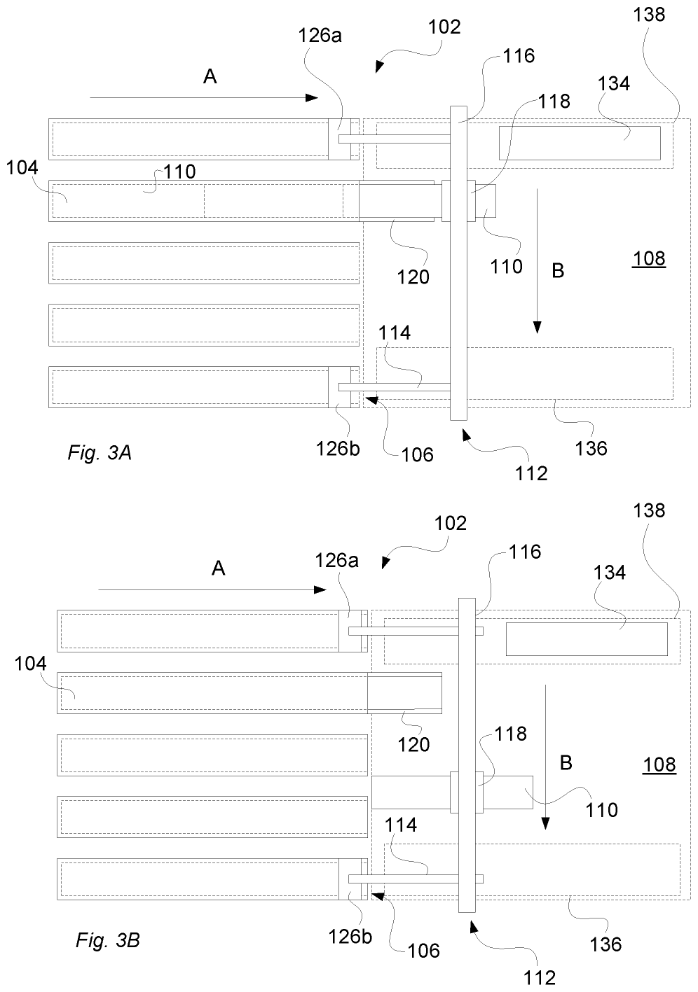

To facilitate handling of the membranes 110 (which is further illustrated in FIGS. 2, 3A and 3B), a lifting arrangement 112 can be used. The lifting arrangement 112 may comprise a support frame 114 that in one end can be attached to the membrane arrangement 102 and in the other end support a beam 116. As illustrated, the beam 116 may be arranged such that it is parallel, or at least substantially parallel, with the common plane 109. This is advantageous in that a gripper unit 118 that is attached to the beam 116 can be moved along the beam 116 and thereby reach different columns 122 of the openings 106 of the membrane housings 104.

Once the gripper unit 118 is aligned with the opening 106 from which the membrane 110 is to be pulled out, a support device 120 (see FIG. 2) may be used for holding the membrane 110 after this has been pulled out from the membrane housing 104, but before being gripped by the gripper unit 118. The support device 120 may be designed in different ways. The support device 120 can be made with an opening in one end such that this may be hooked onto one of the membrane housings 104.

FIG. 2 illustrates the lifting arrangement 112 and the support device 120 in further detail. As illustrated, the lifting arrangement 112 may be attached to the membrane arrangement 102 by using first and second pipe clamps 126a, 126b. These clamps may be arranged around the membrane housings 104. An advantage with this is that the lifting arrangement 112 can be attached to an existing membrane arrangement 102 with no or few modifications needed.

The gripper unit 118, which is generally illustrated in FIG. 2, may be moved along the beam 116 by having a groove 128 in a bottom section of the beam 116. By using this groove 128 in combination with a sliding member 129 held in the groove 128, the gripper unit 118 may be slided along the beam 116 by an operator.

The gripper unit 118 may be attached to the beam 116 via a hoist unit 130 that can lift the gripper unit 118 vertically. The hoist unit 130 may be provided with a motor 131 such that a membrane 110 can be lifted and lowered reliably. Thus, the hoist unit 130 may in combination with the beam 116 provide for that a membrane 110 can be securely transported and aligned with the opening 106 before this is pushed into the membrane housing 104. Using this approach compared to a manual approach, in which the membrane 110 is lifted, aligned and pushed by one and the same operator, reduces the risk of damages to the membrane 110. Reduced damage of the membrane provides for increased efficiency of the membrane system.

The hoist unit 130 may be designed in different ways. Thus, even though the hoist unit 130 illustrated by way of example is provided with the motor 131, it is also possible to have the hoist unit 130 provided without a motor. For instance, the hoist unit 130 can be a manually operated chain telfer.

The gripper unit 118 may be fully suspended by the hoist unit 130. The hoist unit 130 may be arranged vertically above the gripper unit 118. This may mean that the gripper unit 118 is not supported by any structure that is located vertically below the gripper unit 118. In this way space may be freed up below the gripper unit 118 when used for lifting membranes. The gripper unit 118 may be connected to the hoist unit 130 via a flexible connection element 140 such as a chain, a wire, a rope or similar.

To provide for that the membrane 110, while held in the support device 120, can be gripped securely by the gripper unit 118, the support device 120 may have a first and a second guiding wall 132a, 132b. An advantage with these is that the membrane 110 can be guided into the opening 106 of the membrane housing 104 in a way such that the risk of damaging the membrane 110, due to non-alignment, can be reduced. A further advantage is that the first and second guiding walls 132a, 132b can hold the membrane 110 after this has been pulled out via the opening 106 of the membrane housing 104 while the membrane is gripped by the gripper unit 118. Put differently, by using the support device 120 in combination with the gripper unit 118, the operator may first pull out the membrane 110 from the membrane housing 104 into the support device 120. Thereafter, the membrane 110 may be gripped by the gripper unit 118.

As illustrated, the first and second guiding walls 132a, 132b, which extend upwardly from ribs that form a base 132c of the support device 120, may be arranged such that the membrane 110 held in the support device 120 can be gripped by the gripper unit 118 from above. For instance, a height H of the first and second guiding walls 132a, 132b of the support device 120 in a gripping section 133 may be less than half a diameter D of an opening 135 of the support device 120 through which a membrane may be pushed. Further, as illustrated, the height H of the first and second guiding walls 132a, 132b of the support device 120 may be declining towards an outer end of the support device 120.

FIGS. 3A and 3B illustrate an example of how the membrane 110 can be pulled out from the membrane arrangement 102. As illustrated in FIG. 3A, the membrane 110 can be pulled out from the membrane housing 104 into the support device 120. The membrane housings 104 may extend in a first direction A and the beam 116 may extend in a second direction B perpendicular, or at least substantially perpendicular, to the first direction A. The first direction A may be a horizontal direction.

In FIG. 3A, it is illustrated how the membrane 110 is pulled out from the membrane housing 104 via the opening 106 into the support device 120. At this stage, the gripper unit 118 may be held above and at a distance from the membrane 110 held in the support device 120. After the membrane 110 has been completely pulled out from the membrane housing 104, the gripper unit 118 may be lowered and the membrane 110 may be gripped by the gripper unit 118.

In FIG. 3B, it is illustrated how the membrane 110 can be transported in the second direction B by being slided together with the gripper unit 118 along the beam 116. When replacing the membrane 110, the membrane 110 may be dropped off by the gripper unit 118 in a drop off area 136. After the membrane 110 has been dropped off, the gripper unit 118 may be transported to a pick-up area 138 in which a new membrane 134 may be picked up. The new membrane 134 may be picked up by lowering down the gripper unit 118 such that the new membrane 134 can be gripped. After the new membrane 134 is gripped, the gripper unit 118 and the membrane 110 can be transported by being slided along the beam 116 to the support device 120. Thereafter, after the gripper unit 118 is placed above the support device 120, the gripper unit 118 can be lowered such that the new membrane 134 is placed in the support device 120. After being positioned in the support device 120, the new membrane 134 can be released from the gripper unit 118. Finally, after being placed in the support device 120, the new membrane 134 is aligned in the first direction A by the first and second guiding walls 132a, 132b and it can thus be pushed into the membrane housing 104 in a safe and secure manner.

Even though the use of the support device 120 comes with a number of advantages, the membrane 110 can be replaced without using the support device 120. For instance, the membrane 110 may be pulled out halfway from the membrane housing 104 and while the membrane 110 is held in place by the membrane housing 104, possibly in combination with assistance from an operator supporting the membrane 110, the membrane 110 can be gripped by the gripper unit 118. A similar but reverse process may be used for introducing the new membrane 134 into the membrane housing 104. For instance, after the new membrane 134 has been aligned with the opening 106 of the membrane housing 104, a section of the new membrane 134 can be pushed into the membrane housing 104 such that the new membrane 134 is held in place by the membrane housing 104, and thereafter the gripper unit 118 can be released from new membrane 134. Once released, the new membrane 134 can be fully pushed into the membrane housing 104.

The gripper unit 118 may be linked to the hoist unit 130 via a chain 140 or similar. When lifting or lowering the membrane 110, the hoist unit 130 may be held still and the gripper unit 118 may be lifted or lowered together with the membrane 110. Lowering or lifting the membrane 110 may be achieved by reducing or increasing a length of the chain 140 linking the two parts 118, 130. Having the chain 140 also provides for that the membrane 110 as well as the new membrane 134 can be moved in the first direction A such that e.g. the membrane 110 can be pushed into the membrane housing 104 before releasing the gripper unit 118.

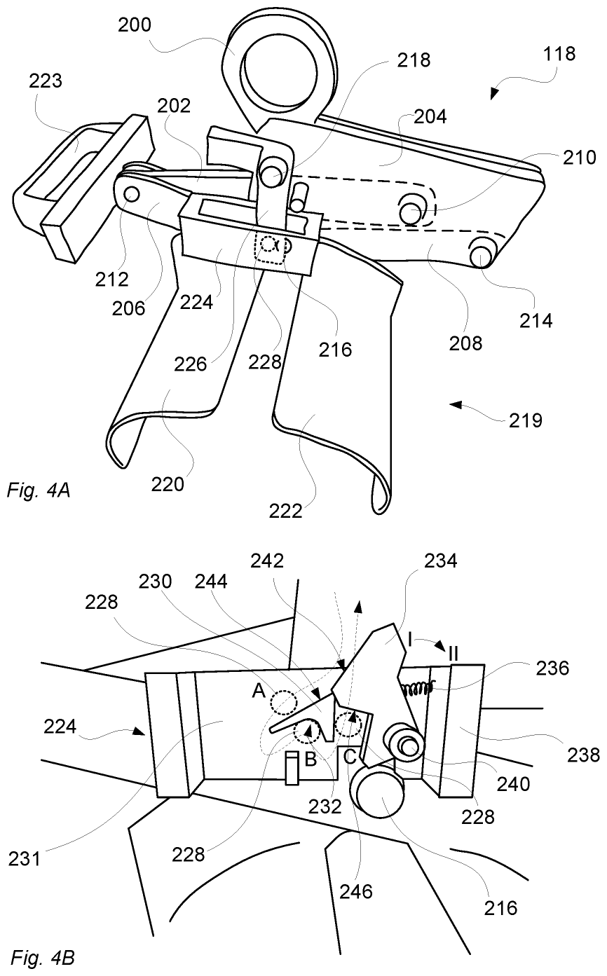

FIG. 4A illustrates the gripper unit 118 by way of example. The example illustrated is a so-called pipe tong 219. In FIG. 4A the gripper unit 118 is illustrated in a release mode.

The gripper unit 118 can comprise an attachment ring 200. When lifting the gripper unit 118 in the attachment ring 200, a first arm 202 and a second arm 204 rotationally connected to each other is lifted such that these extend substantially vertical instead of substantially horizontally. Since the first arm 202 is rotationally connected to a third arm 206, placed below the first arm 202, and the second arm 204 is rotationally connected to a fourth arm 208, placed below the second arm 204, this will have the effect that in turn also the third arm 206 and the fourth arm 208 are changed from extending substantially horizontally to substantially vertically. As illustrated, the first arm 202 can be connected to the second arm 204 in a first rotational point 210, the first arm 202 can be connected to the third arm 206 in a second rotational point 212, the second arm 204 can be connected to the fourth arm 208 in a third rotational point 214, and the third and fourth arm 206, 208 can be connected to each other in a fourth rotational point 216. In the example illustrated, a fifth rotational point 218 is provided above the fourth rotational point 216. Via this fifth rotational point 218, the attachment ring 200 is connected to the second arm 204.

A first membrane holder 220 can be attached to the fourth arm 208 below the fourth rotational point 216, and a second membrane holder 222 can be attached to the third arm 206 below the fourth rotational point 216. In this way, when lifting the gripper unit 118 in the attachment ring 200, the first and second membrane holders 220, 222 will move towards one another and thereby providing for that the membrane 110 can be securely held between the two. When holding the membrane between the first and second membrane holders 220, 222, the gripper unit 118 is referred to be in a grip mode.

When holding the membrane 110 between the first and second membrane holders 220, 222, the hoist unit 130 and the gripper unit 118 can be slided along the beam 116 by the operator. To reduce the risk that the operator is damaging the membrane 110 while sliding along the beam 116, a handle 223 may be provided on the gripper unit 118.

To facilitate releasing and gripping of the membrane 110, a locking device 224 can be provided. The locking device 224, which is further illustrated in FIG. 4B, may interact with a locking element 226 provided with a protrusion 228 in a peripheral end. The protrusion 228 may have the form of a pin, and may be referred to as a locking pin 228. In the example illustrated, the locking element 226 can be connected to the second arm 204 via the fifth rotational point 218. As illustrated, the locking element 226 may be L-shaped. An effect of this L-shape is that a momentum will be formed that will provide for that the protrusion 228 is pushed in accordance with the momentum formed by the L-shape. In this particular example, the protrusion 228 is pushed to the right.

FIG. 4B illustrates the locking device 224 in further detail. For illustrative purposes, a front side of the locking device 224 has been removed. The locking device 224 can comprise a guiding element 230, which may be fixedly attached to a rear side 231 of the locking device 224. The guiding element 230 may comprise a bottom surface recess 232 arranged to hold the protrusion 228.

A tilt element 234 can also be provided. As the name suggests, the tilt element 234 can be tilted between a closed position I, as illustrated, and an open position II. To provide for that the tilt element 234 is in the closed position I when not forced into the open position II, a spring 236 attached to a side wall 238 can be provided. In a lower end of the tilt element 234, a tilt rotational point 240 may be provided.

With the locking device 224 arranged in this way, the protrusion 228 of the locking element 226 when lowered into the locking device 224 can be guided via a slanted top surface 242 of the tilt element 234 and a slanted top surface 244 of the guiding element 230 into a position A. The L-shape of the locking element 226 can provide for that the protrusion 228 is pushed towards the slanted top surfaces 242, 244.

After being guided along the slanted top surfaces 242, 244, the protrusion 228 is introduced into the bottom surface recess 232 of the guiding element 230, herein denoted as position B. In this position, the locking element 226 provides for that the gripper unit 118 is in the release mode, i.e. the first and second membrane members 220, 222 are held apart as illustrated in FIG. 4A.

When having the protrusion 228 placed in the bottom surface recess 232, i.e. position B, and lowering the gripper unit 118 onto the membrane 110, the protrusion 228 will be released from the bottom surface recess 232, move down and thereafter into a position between the guiding element 230 and the tilt element 234, herein denoted position C. When lifting the gripper unit 118, the tilt element 234 can be tilted from the closed position I to the open position II when the protrusion 228 engages the bottom surface 246 of the tilt element 234, such that the protrusion 228 is let through between the guiding element 230 and the tilt element 234. As an effect of that the protrusion 228 is let through, the gripper unit 118 is no longer locked in the release mode, but can enter the grip mode and thereby grip the membrane 110.

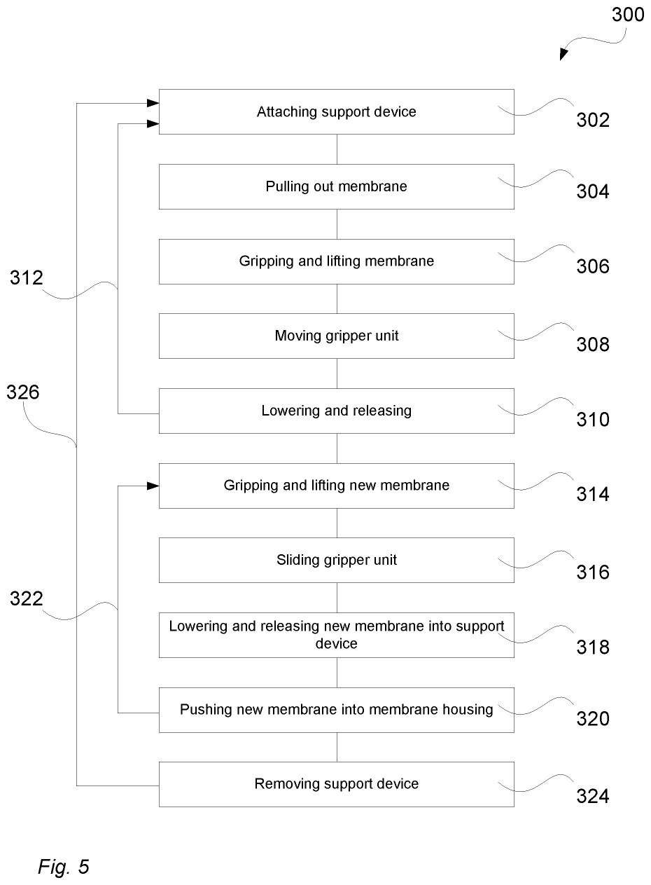

FIG. 5 is a flowchart illustrating a method 300 for replacing membranes 110 in the filtration system 100 by way of example. The method can comprise
a) attaching 302 the support device 120 to the opening 106 of one of the membrane housings 104 of the filtration system 100,
b) pulling 304 the membrane 110 out from the membrane housing 104 and into the support device 120,
c) gripping and lifting 306 the membrane 106 with the gripper unit 118, d) moving 308 the gripper unit 118 with the membrane 106 in the direction B along the common plane 109,
e) lowering and releasing 310 the membrane 106 in the drop off area 136,
f) repeating 312 steps 302, 304, 306, 308 and 310 (b) to e)) until the membrane housing 104 is empty,
g) gripping and lifting 314, from the pick-up area 138, the new membrane 134 with the gripper unit 118,
h) sliding 316 the gripping unit 118 with the new membrane 134 in the direction B along the common plane 109,
i) lowering and releasing 318 the new membrane 134 in the support device 120,
j) pushing 320 the new membrane into the membrane housing 104,
k) repeating 322 steps 314, 316, 318 and 320 (g) to k)) until the membrane housing 104 is full with new membranes 134,
l) removing 324 the support device 120 from the opening 106 of the membrane housing 104, and
m) repeating 326 all steps (a) to l)) for a number of membrane housings 104 of the filtration system 100.

Even though described in a specific order, it should be understood that other orders may be used as well. Further, even though not explicitly described in relation to the method, the different features and advantages described in relation to the filtration system above may also be applied for the method.

From the description above follows that, although various embodiments of the invention have been described and shown, the invention is not restricted thereto, but may also be embodied in other ways within the scope of the subject-matter defined in the following claims.

1. A filtration system comprising
a membrane arrangement comprising
membrane housings extending in a first direction and having openings that are located in a common plane and face a common area, and
membranes arranged inside the membrane housings and configured to be replaced via the openings, and
a lifting arrangement comprising
a support frame having a beam that extends along the common plane and is provided vertically above the common area, and
a gripper unit slidably attached to the beam and arranged to grip the membranes and transport the membranes in a direction along the common plane.

2. The filtration system according to claim 1, wherein the membrane housings are arranged in horizontal rows and vertical columns.

3. The filtration system according to claim 1, wherein the membranes are spiral wound membranes that are arranged in groups in the membrane housings, where the membranes in each group are positioned after one another in the first direction.

4. The filtration system according to claim 1, wherein the beam is provided with a groove to which the gripper unit is connected, for allowing the gripper unit to slide along the beam in the direction along the common plane.

5. The filtration system according to claim 1, wherein the gripper unit is attached to the beam via a hoist unit, the hoist unit comprising a motor arranged to vertically move the gripper unit together with a membrane held by the gripper unit.

6. The filtration system according to claim 1, wherein the gripper unit comprises a pipe tong for gripping a membrane.

7. The filtration system according to claim 1, wherein the gripper unit comprises
a first arm, a second arm, a third arm and a fourth arm, wherein the first arm is connected to the second arm via a first rotational point, the third arm is connected to the first arm via a second rotational point, the fourth arm is connected to the second arm via a third rotational point, and the third arm is connected to the fourth arm via the fourth rotational point,
a first membrane holder attached to the fourth arm, and a second membrane holder attached to the third arm, for allowing the first and second membrane holder to clamp the membrane when the second arm is pulled upwards.

8. The filtration system according to claim 7, wherein the gripper unit comprises a locking device and a locking element, wherein the locking element is rotationally connected to the second arm via a fifth rotational point, said locking device comprising
a guiding element provided with a slanted top surface and a bottom surface recess,
a tilt element rotationally attached via a tilt rotational point and provided with a slanted top surface and a bottom surface,
wherein the said locking element further comprising
a locking pin provided in a peripheral end of the locking element,
such that
when the second arm is lowered the locking pin is introduced into the locking device and guided downwards via the slanted top surface of the tilt element and the slanted top surface of the guiding element,
thereafter, when the second arm is lifted, the locking pin is caught in the bottom surface recess of the guiding element, thereby providing for that the first and second membrane holder are held apart,
thereafter, when the second arm is lowered and lifted, the locking pin is released from the bottom surface recess and pushed through between the guiding element and the tilt element by pushing the tilt element from a closed position to an open position via the bottom surface of the tilt element and out from the locking device.

9. The filtration system according to claim 1, wherein the support frame is fixedly attached relative to the membrane arrangement.

10. The filtration system according to claim 1, wherein the support frame is fixedly attached to the membrane housings.

11. The filtration system according to claim 10, wherein the support frame is attached to the membrane housings via a first and a second pipe clamp.

12. The filtration system according to claim 1, comprising a support device arranged to be connected to one of the membrane housings at the opening of the membrane housing, and configured to support membranes that are pushed into or pulled out from the membrane housing.

13. A lifting arrangement arranged to be fixedly attached relative to a membrane arrangement such that a filtration system according to claim 1 is formed, said lifting arrangement comprising
a support frame having a beam that extends along the common plane and is provided vertically above the common area, and
a gripper unit slidably attached to the beam and arranged to grip the membranes and to transport the membranes in a direction along the common plane.

14. A method for replacing membranes in a filtration system according to claim 12, the membrane housings in the filtration system extending in a horizontal direction, said method comprising
a) attaching the support device to an opening of one of the membrane housings of the filtration system,
b) pulling, in the horizontal direction, a membrane out from the membrane housing and into the support device,
c) gripping and lifting the membrane with the gripper unit,
d) moving the gripper unit with the membrane in the direction along the common plane,
e) lowering and releasing the membrane in a drop off area,
f) repeating steps b) to e) until the membrane housing is empty,
g) gripping and lifting, from a pick-up area, a new membrane with the gripper unit,
h) sliding the gripping unit with the new membrane in the direction along the common plane,
i) lowering and releasing the new membrane in the support device,
j) pushing, in the horizontal direction, the new membrane into the membrane housing,
k) repeating steps g) to j) until the membrane housing is full with new membranes,
l) removing the support device from the opening of the membrane housing, and
m) repeating steps a) to l) for a number of membrane housings of the filtration system.
